(19) United States
(12) Patent Application Publication
(10) Pub. No.: US 2015/0294671 A1
(43) Pub. Date: Oct. 15, 2015

(54) SECURITY ALARM SYSTEM WITH ADAPTIVE SPEECH PROCESSING

(71) Applicant: Honeywell International Inc., Morristown, NJ (US)

(72) Inventors: Eric Oh, Syosset, NY (US); Kenneth L. Addy, Massapequa, NY (US); Bharat Balaso Khot, Bangalore (IN); David S. Zakrewski, Babylon, NY (US)

(73) Assignee: Honeywell International Inc., Morristown, NJ (US)

(21) Appl. No.: 14/253,165

(22) Filed: Apr. 15, 2014

(51) Int. Cl. G10L 17/22; G10L 15/26

(52) U.S. Cl. CPC G10L 17/22; G10L 15/26

(57) ABSTRACT

A regional monitoring system includes speech recognition circuitry having smart filtering capability to interpret speech input from a user to provide interactions between the user and the system. Received voice commands can be filtered using key words to interpret security commands which can then be executed. The system can provide audible feedback using one or more of prerecorded voice data files or synthesized speech.

### FIELD

The application pertains to regional monitoring systems. More particularly, the application pertains to such systems which provide an easy to use interface to facilitate expanded or more complex user interactions with such systems.

### BACKGROUND

Traditional security alarm systems are not intuitive to use by end users. The typical fixed icon numeric keypads don't provide much assistance to help users interact with the system. Users typically have to memorize a fixed set of keystrokes or press buttons based on a menu flow to enter commands to the system. Most average users end up only using a few of the basic commands and can be intimidated by the system's user interface and not inclined to use other advanced features of the system.

It would be desirable to provide an easier to use interface for such systems. Ease of use can be expected to result in expanded use of advanced features of such systems.

### BRIEF DESCRIPTION OF THE DRAWINGS

FIG. 1 illustrates a block diagram of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In one aspect hereof, speech recognition with smart filtering technology is used in regional monitoring systems to interpret user audible or speech commands to provide smooth and intuitive interactions between the user and system. For example, basic and advanced security functions such as bypass, arming, get status, set operation mode can be smoothly and intuitively invoked by the user.

Embodiments hereof use speech-to-text technology to process audible, or, voice commands in the form of text phrases. Received audible, or voice commands are filtered through preconfigured key words to interpret security commands specific to the security system. Those commands are then executed. Some speech commands will not require any speech reply and others will. For the commands that require audible status replies, the system could use a combination of prerecorded voice audio files and text-to-speech responses. Example commands include “system arm,” “system disarm” and code, “leaving home,” “cameras,” “show weather,” and “house status.” Many other commands can be provided.

In yet another aspect, embodiments hereof can leverage any speech-to-text solution that processes a received text phrase and parses the entire phrase to extract the key words to compare against a list of preprogrammed and real-time adaptive security commands. The list of preprogrammed words can be stored in the system's command list and device descriptor tables. Examples of these preprogrammed words include “Den”, “door”, “window”, “arm away”, “bypass”, “check status”, . . . etc.

The list of real-time adaptive words could be created or expanded by installers or users by typing the words or speaking the words to a user interface device such as the keypad or mobile device. An installer could add specific words for a particular installation—so that voice recognition is not necessarily required, but speech recognition would still work. So for example “bedroom” and “window” could be in the pre-loaded database of fixed words, but the installer could add locally (or via download) e.g. “Johnny's”, so that a phrase like “Johnny's bedroom window bypass” would be recognizable. The real-time vocabulary list could also adapt to each user's speech preference, grammar and accent.

The adaptive real-time vocabulary list can grow accordingly within each individual system based on the number of devices connected and the frequency of speech command usage. There could be a local database of fixed words and a local database of installer or end-user custom words in the database that could be combined to personalize the installation.

Disclosed embodiments can also provide voice feedback and security status replies back to user via a combination of prerecorded phrases and text-to-speech response. The prerecorded phrases can be pre-stored in respective security systems. Examples include, without limitation, “system disarm”, “ready to arm”, and “fault front door”.

Text-to-speech capabilities provide enhanced voice responses to users, where the system needs to reply, based on an adaptive real-time vocabulary list. As the real-time vocabulary list is built by adaptive words and phrase automated training, the vocabulary could be used to construct appropriate text-to-speech responsive phrases.

In embodiments hereof, interactive automated voice assistance provides prompted help for users to complete an advanced function such as bypassing a zone. For example where a user has the intention to bypass a window, but is not sure how to direct the system in one complete sentence, the user can start by asking the system to “bypass window”. In response, the system can ask “which one”? The user can respond by saying “Johnny's bedroom window”. The system in response executes the bypass and provides a voice confirmation back to the user.

In yet another aspect, voice assistance can be integrated with a displaced security central monitoring station and service to send and receive messages to and from a customer services department. Such embodiments can provide automated processing of user requests for upgrades, bill payments or the other services. Additionally such displaced stations/services can notify users of service issues, local cell tower issues, and the like all without limitation.

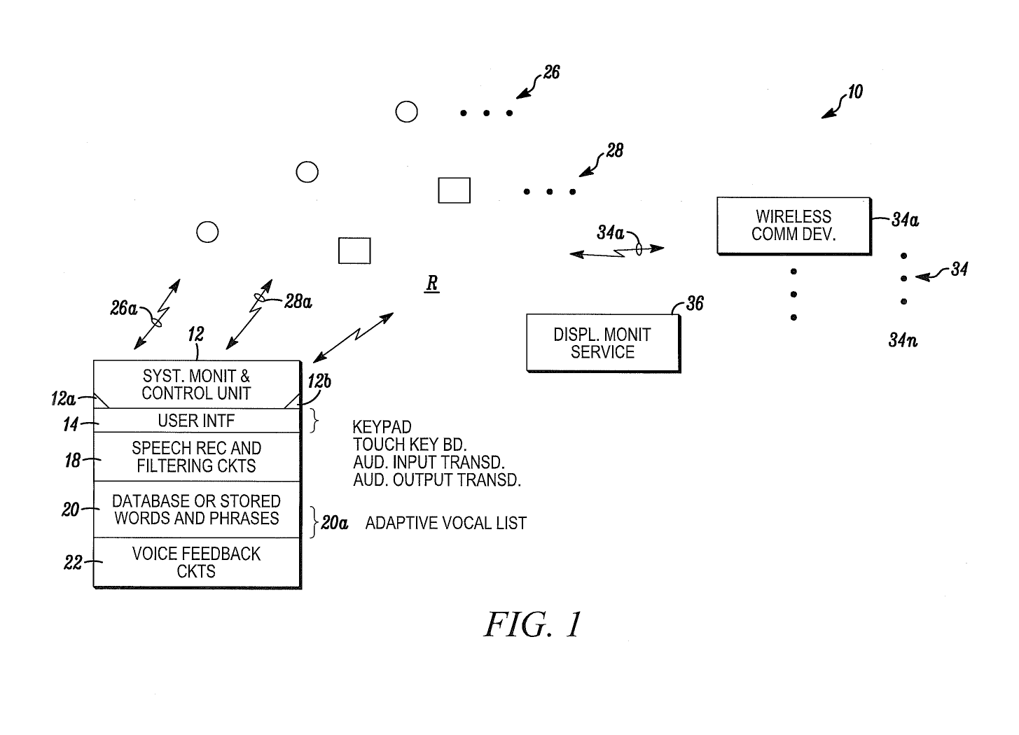

FIG. 1 illustrates a system 10 in accordance herewith. System 10 includes a system monitoring and control unit 12. Unit 12 can be implemented at least in part, by a programmable processor 12a, and, executable control software 12b. Unit 12 includes a user interface 14, speech recognition and filtering circuitry, which might in part, be implemented by processor 12a and instructions 12b.

Unit 12 can also include a data base 20. The data base 20 can include pre-stored words and phrases that form an adaptive vocabulary list 20a. Voice feedback circuitry 22 can also be included in the unit 12.

A plurality of sensors 26 can be installed in a region R and wired or wirelessly coupled to unit 12. A plurality of actuators 28 can be located in the region R and can be wired or wirelessly coupled to unit 12. Those of skill will understand that the respective mediums 26a, 28a can include one or more wireless computer networks such as the Internet, or an intranet.

A plurality of wireless communications devices 34, such as smart phones, tablet computers and the like can be in wireless communications via medium 34a. The medium 34a can include one or more wireless computer networks such as the Internet or an intranet.

A displaced monitoring station or service 36 can be in communication with unit 12 via the medium 34a. The plurality 26 can include security detectors such as motion sensors, glass break detectors as well as ambient condition sensors such as smoke, gas or fire sensors and the like all without limitation. The plurality 28 can include equipment control devices to control fans, lighting or AC for example, or, alarm indicating output devices or door access control devices all without limitation.

In summary, embodiments hereof, such as system 10, use speech-to-text technology to process received audible, or, voice commands, via interface 14 or devices 34, in the form of text phrases, as in circuitry 18, 20. Received audible, or voice commands, via interface 14 or devices 34, are filtered through preconfigured key words to interpret security commands specific to the security system, via circuitry 18 and data base 20. Those commands are then executed, via control circuitry 12 and actuators 28. Some speech commands will not require any speech reply and others will. For the commands that require audible status replies, the system 10 could use a combination of prerecorded voice audio files and text-to-speech responses and voice feedback circuits 22.

In yet another aspect, voice assistance can be integrated with a displaced security central monitoring station and service 36 to send and receive messages to and from a customer services department. Such embodiments can provide automated processing of user requests for upgrades, bill payments or the other services. Additionally such displaced stations/services 36 can notify users of service issues, local cell tower issues, and the like all without limitation.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A monitoring system comprising a manually operable user interface device coupled, at least intermittently, to a speech-to-text component and a text phrase parser component in combination to extract user speech keywords that match a list of preprogrammed and adaptive real-time security commands and wherein the system executes the commands.

2. A system as in claim 1 wherein the phrase parser component includes a plurality of preprogrammed words extracted from commands and device descriptor tables.

3. A system as in claim 2 wherein the words are from security system's control action list and various device descriptor tables selected from a class that includes at least a zone list table, an event table, partition table, or a user table.

4. A system as in claim 1 which includes a local database of fixed words and a local database of installer or end-user custom words that could be combined to personalize the installation.

5. A system as in claim 1 wherein that the phrase parser component comprises real-time adaptive words added by users by typing or speaking the words to a user interface device comprising at least one of keypad or mobile device.

6. A system as in claim 5 wherein the real-time vocabulary list is adaptable to each user's speech preference, grammar or accent.

7. A system as in claim 6 wherein the real-time vocabulary list can expand accordingly within each individual system based on the number of connected devices and the frequency of speech command usage.

8. A system as in claim 1 wherein interactive automated voice assistance can provide feedback for the end user to complete a selected command or a selected function.

9. A system as in claim 8 wherein a command or function can be selected from a class which includes at least, system arm, system disarm and code, leaving house, cameras, show weather, show house status, bypass zone, or bypass window.

10. A system as in claim 8 wherein when a user verbally directs the system to bypass a window, the system asks which one, and the user responds by specifying a window, and, wherein the system repeats and acknowledges the request.

11. A system as in claim 4 wherein an Installer could add specific words for a particular installation such that “bedroom” or “window” could be in the pre-loaded database of fixed words, but the installer could add locally (or via download) selected words or phrases so that an expanded would be recognizable.

12. A method comprising:
providing a user interface device and including a text-to-speech component and providing a prerecorded system status phrase component to provide user speech status feedback and audio responses confirming actions that have been executed

13. A method as in claim 12 wherein received phrases are parsed to extract keywords.

14. A method as in claim 13 which includes comparing the keywords against a list of pre-programmed words.

15. A method as in claim 14 which includes adding real-time adaptive words or phrases to the list.

16. A method as in claim 15 which includes adapting to a user's speech preference, grammar and accent.

17. A method as in claim 15 which includes providing a database of predetermined words and custom words to be combined with the predetermined words.

18. A security system comprising a user interface device that includes a text-to-speech component and a prerecorded system status phrase component in combination to provide user speech status feedback and audio responses confirming actions executed by the security system.

19. A system as in claim 18 wherein the interface device comprises a manually operable device selected from a class which includes at least one of a key pad, a plurality of switches, a touch sensitive keyboard, a wireless communications device.

20. A system as in claim 19 which includes interactive automated voice assistance which can provide prompted help for an end user to complete a selected function.
